(19) United States
(12) Patent Application Publication
(10) Pub. No.: US 2008/0307118 A1
(43) Pub. Date: Dec. 11, 2008

(54) Management method for use of extended display identification data

(75) Inventor: Shih-Hua Tseng, Taipei (TW)

Correspondence Address: BACON & THOMAS, PLLC, 625 SLATERS LANE, FOURTH FLOOR, ALEXANDRIA, VA, 22314-1176, US

(73) Assignee: Tatung Company, Taipei (TW)

(21) Appl. No.: 12/003,535

(22) Filed: Dec. 28, 2007

(30) Foreign Application Priority Data
Jun. 8, 2007 (TW) 096120886

(51) Int. Cl. G06F 3/14

(52) U.S. Cl. 710/8

(57) ABSTRACT

The present invention provides a management method for use of extended display identification data (EDID), which is applied to manage a plurality of EDID burning device groups. At least one EDID burning device of each EDID burning device group is electronically connected to an EDID management server via a connection, or the EDID management server is further coupled to a network management server via a network. Therefore, the simple-structure and light-volume EDID burning device of the group could directly update EDID, so as to achieve the purpose of collectively managing EDID.

### BACKGROUND OF THE INVENTION

1. Field of the Invention

The present invention relates to a data management method, and more particularly, to a management method for use of extended display identification data.

2. Description of Related Art

With the popularity of computer technology, the plug and play function becomes an essential function of computer peripheral equipment. As to a display device, the video electronics standard association (VESA) is responsible for promoting and developing important display device and display interface standards, so as to make sure its commonality. Extended display identification data (EDID) standard is one of the standard data formats established by VESA. EDID includes basic data of a display device, such as: manufacturer information, maximum image size, color feature, usage frequency limitation, and etc. The EDID is stored in a display device and used for communicating with a computer host, thereby achieving the plug and play function.

In the past decades, as shown in FIG. 1, display manufacturers always store EDID corresponding to a plurality of different type displays respectively into storage medium such as a floppy 931, a hard drive 932 or a portable drive 933, and connect to a PC frame 93 formed by a computer 930 as a main frame for an EDID burning operation, so as to connect to a VGA interface 911, a DVI interface 912 or a HDMI interface 913 of a to-be-burned display device 91 through an interface converting device 95, thereby writing the EDID into a non-erasable memory of the display device 91. That is, if it is going to perform a burning operation to an A-47 type display device, but the burning EDID of the A-47 type display device is stored in the floppy 931, the manufacturing operator has to utilize a barcode scanner 92 and the computer 930 to read the EDID from the floppy 931, and then write the EDID into the display device via a VGA interface.

However, in the past, operations of reading, burning and editing the EDID were all executed on the basis of a huge-volume PC frame, which not only caused problems in the aspects of energy, equipment cost and maintenance expenses, but also caused the problem of unable to immediately update the EDID in the storage medium, even resulting in a serious management problem such as the difficulty of controlling data flows.

Therefore, it is desirable to provide a management system and method for use of extended display identification data to mitigate and/or obviate the aforementioned problems.

### SUMMARY OF THE INVENTION

In order to solve the abovementioned problems, the present invention provides a management method for use of extended display identification data (EDID), for transmitting data between an EDID management server and an EDID burning device. The EDID management server is connected to the EDID burning device via an EDID management server connection interface. The EDID burning device is defined with a first identification code and comprises a memory unit. The memory unit is stored with the first identification code and an EDID. The EDID burning device has a plurality of video interfaces for connecting to a display device. The EDID management server comprises a database for storing a plurality of second identification codes and a plurality of EDID. The method of the present invention comprises: (A) the EDID management server loading previously used EDID; (B) determining whether the EDID management server and the EDID burning device are connected; (C) if determined that the EDID management server and the EDID burning device are connected, determining whether to load new EDID; (D) if determined not to load the new EDID, determining whether the EDID burning device and the plurality of video interfaces are connected to the display device; (E) if determined that the plurality of video interfaces are connected to the display device, determining whether to execute a download program; (F) if determined to execute the download program, determining whether the first identification code of the EDID burning device corresponds to the second identification codes stored in the database of the EDID management server; and (G) if determined that the first identification code of the EDID burning device corresponds to the second identification codes stored in the database of the EDID management server, the EDID management server downloading corresponding EDID and a control code to the EDID burning device.

Further, the present invention could utilize a network to further provide another management method for use of extended display identification data (EDID), wherein a plurality of EDID burning device groups are connected to an EDID management server via a connection, and a plurality of EDID management servers are connected to a network management server via the network for transmitting data with each other. Each EDID burning device group comprises an EDID management server and at least one EDID burning device. Each EDID burning device is defined with a first identification code and comprises a memory unit. The memory unit is stored with the first identification code and an EDID. The network management server comprises a database for storing a plurality of second identification codes and a plurality of EDID. The method of the present invention comprises: (A) the EDID management server loading previously used EDID; (B) determining whether the EDID management server and the EDID burning device are connected; (C) if determined that the EDID management server and the EDID burning device are connected, determining whether to load new EDID or to combine and load new EDID; (D) if determined not to load the new EDID, determining whether the EDID burning device and a plurality of video interfaces are connected to a display device; (E) if determined that the plurality of video interfaces are connected to the display device, determining whether the EDID management server and the network management server are connected; (F) if determined that the EDID management server and the network management server are connected, determining whether to execute a download program; (G) if determined to execute the download program, determining whether the first identification code of the EDID burning device corresponds to the second identification codes stored in the database; and (H) if determined that the first identification code of the EDID burning device corresponds to the second identification codes stored in the database, the EDID management server downloading corresponding EDID and a control code from the network management server, and downloading the EDID and the control code to the EDID burning device.

### BRIEF DESCRIPTION OF THE DRAWINGS

FIG. 1 illustrates a conventional system schematic drawing.

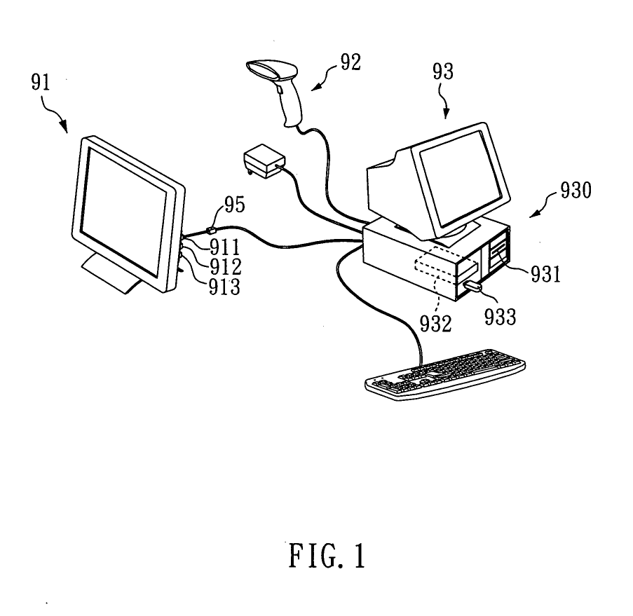

FIG. 2 illustrates a system schematic drawing of one preferred embodiment according to the present invention.

FIG. 3 illustrates a schematic drawing of an EDID burning device of one preferred embodiment according to the present invention.

FIG. 4 illustrates a flowchart of one preferred embodiment according to the present invention.

FIG. 5 illustrates a schematic drawing of a software interface corresponding to the management method for use of extended display identification data of the present invention.

FIG. 6 illustrates a system schematic drawing of another preferred embodiment according to the present invention.

FIG. 7 illustrates a flowchart of another preferred embodiment according to the present invention.

### DETAILED DESCRIPTION OF THE PREFERRED EMBODIMENT

Below please find specific embodiments to explain the implementation of the present invention, such that a person skilled in the art could easily understand the advantage and effect of the present invention according to the disclosure of this specification.

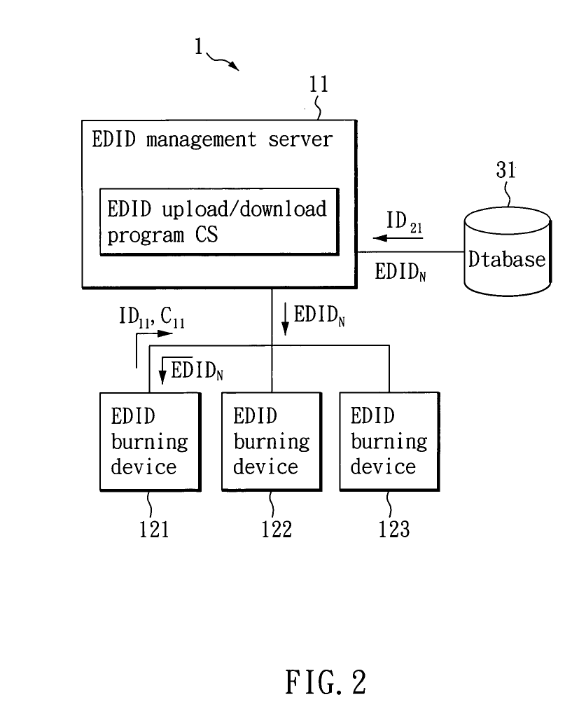

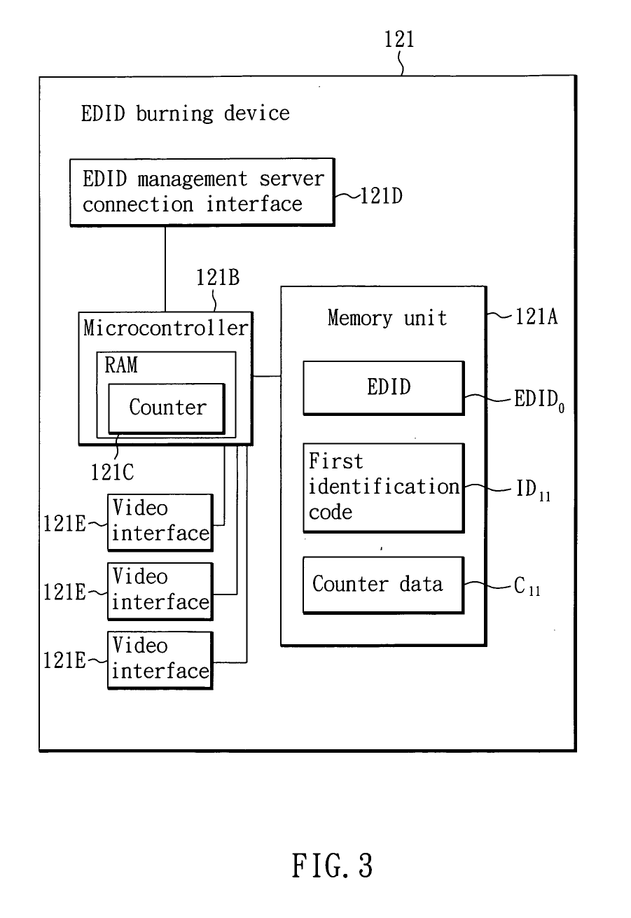

Please refer to both FIG. 2 and FIG. 3. FIG. 2 illustrates a system schematic drawing of the management method for use of extended display identification data (EDID) according to the present invention, while FIG. 3 illustrates a schematic drawing of an EDID burning device of one preferred embodiment according to the present invention. As shown in FIG. 2 and FIG. 3, the system of the present invention comprises at least one EDID burning device group 1. The EDID burning device group 1 comprises an EDID management server 11, a database 31, and multiple EDID burning devices 121, 122, 123. In this embodiment, three EDID burning devices 121, 122, 123 are used as an example for a detailed description. Please note that because the relevant explanation of each EDID burning device 121, 122, 123 is similar, this embodiment only takes the EDID burning device 121 as an example.

In this embodiment, the EDID burning device 121 is defined with a first identification code ID₁₁, and comprises a memory unit 121A, a microcontroller 121B, an EDID management server connection interface 121D and a plurality of video interfaces 121E.

The memory unit 121A is stored with the first identification ID₁₁, an extended display identification data EDID_{O}, and counter data C₁₁. In this embodiment, the memory unit 121A is an electrically erasable programmable read-only memory (EEPROM).

The microcontroller 121B comprises a random access memory (RAM) which has a counter 121C, and is electronically connected to the memory unit 121A. The counter 121C is used to accumulate an EDID burning time, and stores the EDID burning time to the counter data C₁₁ of the memory unit 121A.

The EDID management server connection interface 121D is electronically connected to the microcontroller 121B for connecting to the EDID management server 11. For the convenience of explanation, in this embodiment, the EDID management server connection interface 121D is preferably a RS232 serial interface.

In this embodiment, the plurality of video interfaces 121E are preferably a VGA interface, a HDMI interface and a DVI interface. The EDID burning device 121 writes the EDID into a non-erasable memory of a display device (not shown in figures) via the plurality of video interfaces 121E. The scope of the plurality of video interfaces 121E of the present invention is not limited to the above disclosure.

Further, the EDID management server 11 comprises a database 31, which stores a plurality of second identification codes (please note that FIG. 2 only shows a second identification code ID₂₁ corresponding to the first identification ID₁₁) and a plurality of EDID (please not that FIG. 2 only shows an extended display identification data EDID_{N}). The EDID management server 11 comprises an EDID upload/download program CS for executing the flow of the management method for use of extended display identification data.

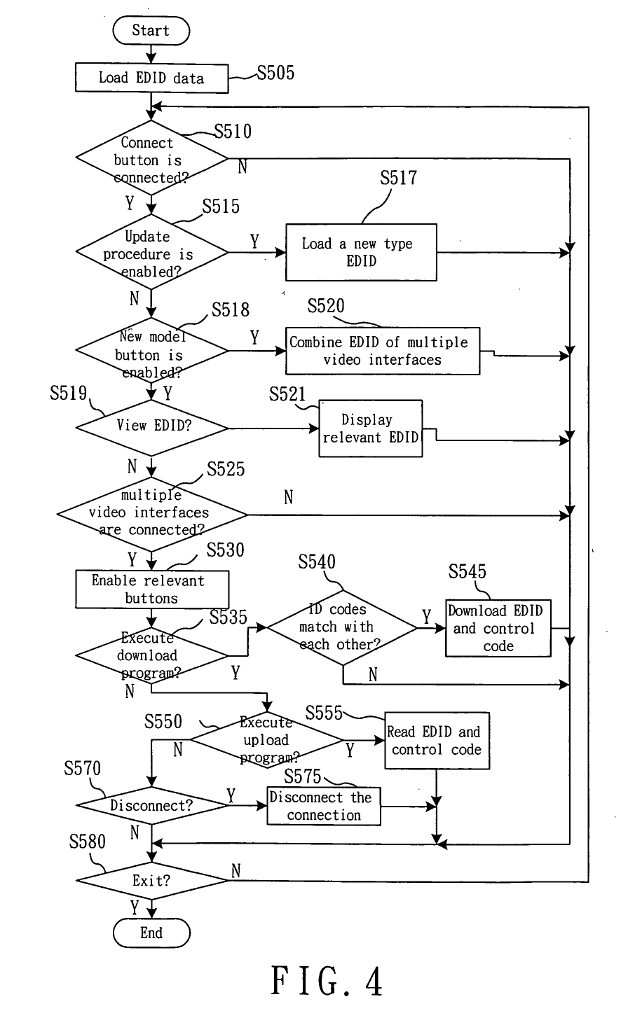

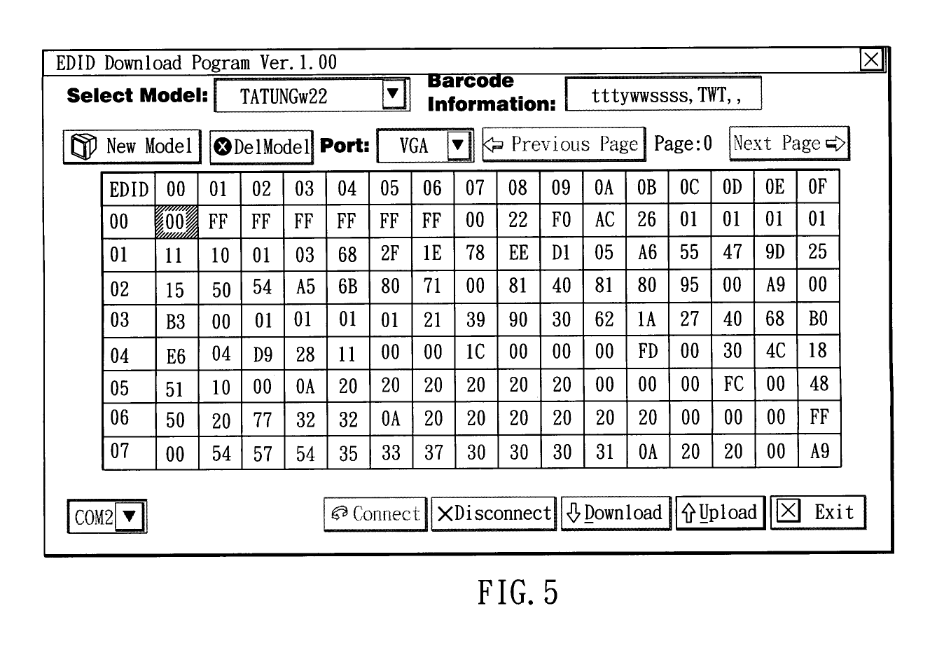

FIG. 4 illustrates a flowchart of one preferred embodiment according to the present invention, and FIG. 5 illustrates a schematic drawing of a software interface corresponding to the management method for use of extended display identification data of the present invention. As for the detailed description of FIG. 4 and FIG. 5, please also refer to FIG. 2 and FIG. 3.

Firstly, step S505 loads previously used EDID. In the present invention, whenever the software of the management method for use of extended display identification data is executed in the server 11, it would always load the EDID previously used by the software from the database 31 of the EDID management server 11, so as to avoid the procedure of requiring the user to assign required EDID, thereby increasing the convenience of use.

Step S510 checks whether a connect button of the software is connected. If the EDID management server 11 detects that it is connected to the EDID burning device 121 via the EDID management server connection interface 121D, that is to say, the connect button of the software is connected, and then step S515 would be executed. If the EDID management server 11 detects that it is not connected to the EDID burning device 121, that is to say, the connect button of the software is not connected (the connect button would be shown in gray color), and then step S580 would be executed. In this embodiment, the EDID management server connection interface 121D is preferably a RS232 serial interface.

Step S515 checks whether an update procedure of the software is enabled. If a new type is inputted via an input model, the software is required to load a new type EDID (i.e. corresponding to the type inputted via the select model) from the database 31 of the EDID management server 11. If the update procedure of the software is enabled, step S517 would be executed; otherwise, step S518 would be executed.

Step S517 loads a new type EDID.

Step S518 checks whether a new model button of the software is enabled. If the new model button of the software is pressed, the software is required to combine and load the new type EDID from the database 31 of the EDID management server 11. If the new model button of the software is enabled, step S520 would be executed; otherwise, step S519 would be executed.

Step S520 not only loads the new type EDID, but also combines the new type EDID with the EDID of the plurality of video signals to be the same type, and then stores into the database 31 for next time access. Because in this embodiment, the EDID of the plurality of video signals are VGA, HDMI and DVI, step S520 could combine the EDID of VGA, HDMI and DVI, such that the user is not required to respectively load the EDID of VGA, HDMI and DVI, thereby increasing the convenience of use.

Step S519 determines whether to execute an EDID review program based on whether a review button of the software is pressed. If yes, step S521 would be executed; otherwise, step S525 would be executed. Step S521 displays relevant EDID.

Step S525 determines whether the plurality of video interfaces 121E of the EDID burning device 121 are connected to a display device (not shown in figures). If not, step S580 would be executed; otherwise, step S530 would be executed.

Step S530 enables relevant buttons of the software, including enabling the download button, the upload button and the disconnected button.

Step S535 determines whether to execute a download program based on whether the download button of the software is pressed. If yes, step S540 would be executed; otherwise, step S550 would be executed.

Step S540 determines whether the first identification code ID₁₁ of the EDID burning device 121 matches with the second identification code ID₂₁ stored in the database 31. If yes, step S545 would be executed; otherwise, step S580 would be executed.

In step S545, since the first identification code ID₁₁ matches with the second identification code ID₂₁ stored in the database 31, the EDID management server 11 downloads relevant EDID and a control code from the database 31 to the EDID burning device 121, and also updates the counter data C₁₁ of the EDID burning device 121. However, before the update, the counter data C₁₁ would be uploaded to the database 31 of the EDID management server 11 first, such that the system could efficiently manage the EDID burning time as a reference to charge the user in the future.

Step S550 determines whether to execute an upload program based on whether the upload button of the software is pressed. If yes, step S555 would be executed; otherwise, step S570 would be executed.

Step S555 reads and transmits the EDID and the control code of the EDID burning device 121 to the EDID management server 11 for comparing with the EDID and the control code stored in the database, so as to confirm whether the data transmitted to the EDID burning device 121 is correct.

Step S570 determines whether to disconnect. If yes, step S575 would be executed; otherwise, step S580 would be executed. Step S575 disconnects the connection between the EDID management server 11 and the EDID burning device 121, and disables the download button, the upload button and the disconnected button.

Step S580 determines whether to end the software based on whether an exit button of the software is pressed. If yes, ends the software; otherwise, step S510 would be executed.

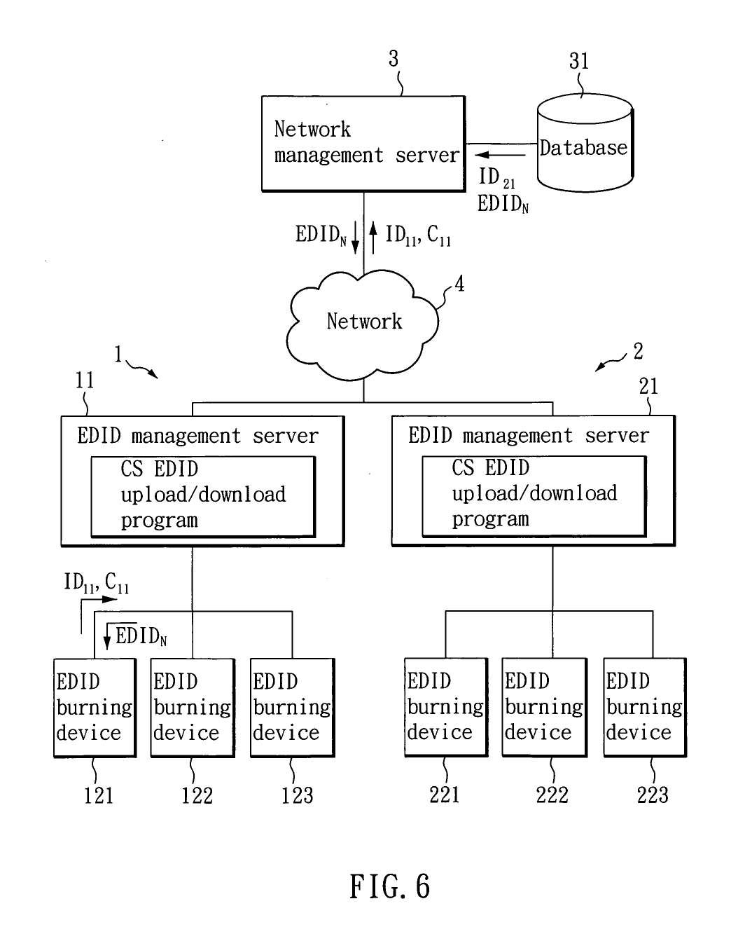

FIG. 6 illustrates a system schematic drawing of another preferred embodiment according to the present invention. As shown in FIG. 6 and FIG. 3, the system of implementing the management method for use of extended display identification data of this embodiment according to the present invention comprises multiple EDID burning device groups 1, 2, a network management server 3 and a database 31. In this embodiment, two EDID burning device groups 1, 2 are used as an example for a detailed description.

Each EDID burning group 1, 2 comprises an EDID management server 11, 21, and multiple EDID burning devices 121, 122, 123, 221, 222, 223. In this embodiment, six EDID burning devices 121, 122, 123, 221, 222, 223 are used as an example for a detailed description. Please note that because the relevant explanation of each EDID burning devices 121, 122, 123, 221, 222, 223 are similar, this embodiment only takes the EDID burning device 121 as an example.

The major difference between this and the previous embodiment is: a network management server 3 is newly added to this embodiment. The network management server 3 is coupled to the EDID management server 11, 21 of each EDID burning device group 1, 2 via a network 4. Further, a database 31 has been moved from the EDID management server 11, 21 to the network management server 3 and electronically connected to each other. The database 31 stores a plurality of second identification codes (please note that FIG. 6 only shows a second identification code ID₂₁ corresponding to the first identification ID₁₁) and a plurality of EDID (please not that FIG. 6 only shows an extended display identification data EDID_{N}). Each EDID management server 11, 12 comprises an EDID upload/download program CS for executing the flow of the management method for use of extended display identification data.

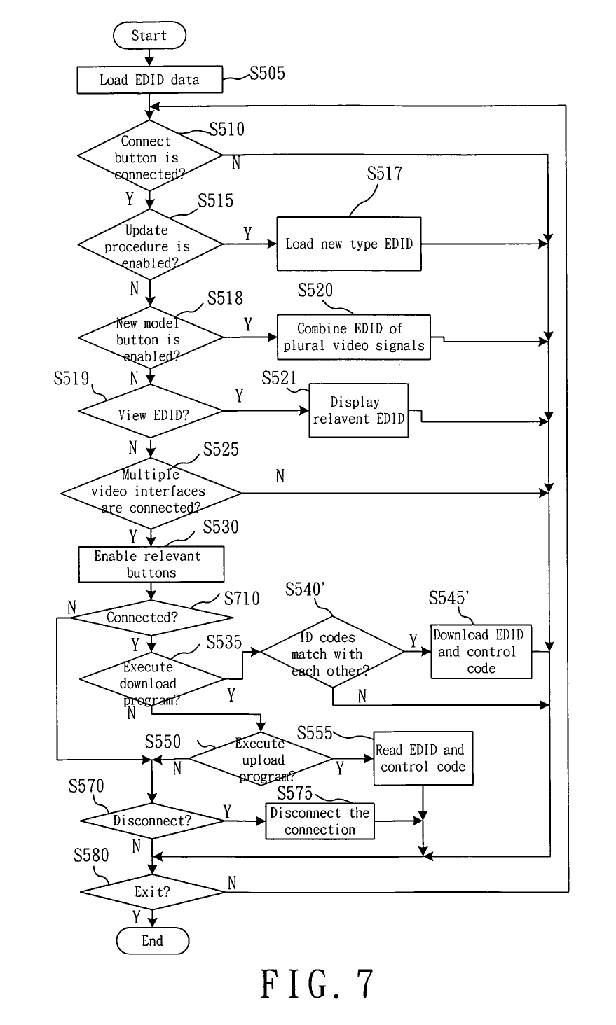

FIG. 7 illustrates a flowchart of this preferred embodiment according to the present invention. The major differences between the flowcharts of FIG. 4 and FIG. 7 are: step S710, step S540′ and step S545′ are newly added to FIG. 7.

Step S710 determines whether the EDID management server 11 is connected to the network management server 3. If yes, step S535 would be executed; otherwise, step S570 would be executed.

Step S540′ determines whether the first identification code ID₁₁ of the EDID burning device 121 matches with the second identification code ID₂₁ stored in the database 31 of the network management server 3. If yes, step S545′ would be executed; otherwise, step S580 would be executed.

In step S545′, since the first identification code ID₁₁ matches with the second identification code ID₂₁ stored in the database 31, the EDID management server 11 downloads the EDID and the control code stored in the database 31 of the network management server 3 to the EDID burning device 121 via the network 4, and also updates the counter data C₁₁ of the EDID burning device 121. However, before the update, the counter data C₁₁ would be uploaded to the database 31 of the network management server 3 via the network 4 first, such that the system could efficiently manage the EDID burning time as a reference to charge the user in the future.

Although the present invention has been explained in relation to its preferred embodiment, it is to be understood that many other possible modifications and variations can be made without departing from the spirit and scope of the invention as hereinafter claimed.

What is claimed is:

1. A management method for use of extended display identification data (EDID), for transmitting data between an EDID management server and an EDID burning device, the EDID management server connected to the EDID burning device via an EDID management server connection interface, the EDID burning device defined with a first identification code and comprising a memory unit, the memory unit stored with the first identification code and an EDID, the EDID burning device having a plurality of video interfaces for connecting to a display device, the EDID management server comprising a database for storing a plurality of second identification codes and a plurality of EDID, the method comprising:
(A) the EDID management server loading previously used EDID;
(B) determining whether the EDID management server and the EDID burning device are connected;
(C) if determined that the EDID management server and the EDID burning device are connected, determining whether to load new EDID or to combine and load new EDID;
(D) if determined not to load the new EDID, determining whether the EDID burning device and the plurality of video interfaces are connected to the display device;
(E) if determined that the plurality of video interfaces are connected to the display device, determining whether to execute a download program;
(F) if determined to execute the download program, determining whether the first identification code of the EDID burning device corresponds to the second identification codes stored in the database of the EDID management server; and
(G) if determined that the first identification code of the EDID burning device corresponds to the second identification codes stored in the database of the EDID management server, the EDID management server downloading corresponding EDID and a control code to the EDID burning device.

2. The management method as claimed in claim 1, wherein if step (B) determines that the EDID management server and the EDID burning device are not connected, programs of uploading and downloading EDID would be prohibited, and then returns to the flow waiting for next time determination.

3. The management method as claimed in claim 2, wherein if step (C) determines to load the new EDID, a new type EDID would be loaded from the database of the management server, if step (C) determines to combine and load the new EDID, the new type EDID would be combined and loaded from the database of the EDID management server.

4. The management method as claimed in claim 3, wherein if step (D) determines that the plurality of video interfaces are not connected to the display device, programs of uploading and downloading EDID would be prohibited, and then returns to the flow waiting for next time determination.

5. The management method as claimed in claim 4, wherein if step (E) determines not to execute the download program, it further comprising the following steps:
(H) determining whether to execute an upload program; and
(I) if determined to execute the upload program, reading and transmitting the EDID and the control code of the EDID burning device to the EDID management server, and comparing with the EDID and the control code stored in the database of the EDID management server.

6. The management method as claimed in claim 5, wherein the following steps are included between step (C) and step (D):
(J) determining whether to execute an EDID review program; and
(K) if determined to execute the EDID review program, displaying relevant EDID.

7. The management method as claimed in claim 1, wherein step (G) further comprises:
(G1) uploading counting value data of the EDID burning device to the database of the EDID management server, and updating counter data of the EDID burning device.

8. A management method for use of extended display identification data (EDID), for transmitting data between a plurality of EDID burning device groups and a network management server via a network, wherein each EDID burning device group comprises an EDID management server and at least one EDID burning device, each EDID burning device defined with a first identification code and comprising a memory unit, the memory unit stored with the first identification code and an EDID, the network management server comprising a database for storing a plurality of second identification codes and a plurality of EDID, the method comprising:
(A) the EDID management server loading previously used EDID;
(B) determining whether the EDID management server and the EDID burning device are connected;
(C) if determined that the EDID management server and the EDID burning device are connected, determining whether to load new EDID or to combine and load new EDID;
(D) if determined not to load the new EDID, determining whether the EDID burning device and a plurality of video interfaces are connected to a display device;
(E) if determined that the plurality of video interfaces are connected to the display device, determining whether the EDID management server and the network management server are connected;
(F) if determined that the EDID management server and the network management server are connected, determining whether to execute a download program;
(G) if determined to execute the download program, determining whether the first identification code of the EDID burning device corresponds to the second identification codes stored in the database; and
(H) if determined that the first identification code of the EDID burning device corresponds to the second identification codes stored in the database, the EDID management server downloading corresponding EDID and a control code from the network management server, and downloading the EDID and the control code to the EDID burning device.

9. The management method as claimed in claim 8, wherein if step (B) determines that the EDID management server and the EDID burning device are not connected, programs of uploading and downloading EDID would be prohibited, and then returns to the flow waiting for next time determination.

10. The management method as claimed in claim 8, wherein if step (C) determines to load the new EDID, a new type EDID would be loaded from the database of the EDID management server, if step (C) determines to combine and load the new EDID, the new type EDID would be combined and loaded from the database of the EDID management server.

11. The management method as claimed in claim 8, wherein if step (D) determines that the plurality of video interfaces are not connected to the display device, programs of uploading and downloading EDID would be prohibited, and then returns to the flow waiting for next time determination.

12. The management method as claimed in claim 8, wherein if step (E) determines that the EDID management server and the network management server are not connected, programs of uploading and downloading EDID would be prohibited, and then returns to the flow waiting for next time determination.

13. The management method as claimed in claim 8, wherein if step (F) determines not to execute the download program, it further comprising the flowing steps:
(I) determining whether to execute an upload program; and
(J) if determined to execute the upload program, reading and transmitting the EDID and the control code of the EDID burning device to the network management server, and comparing with the EDID and the control code stored in the database of the network management server.

14. The management method as claimed in claim 13, wherein the following steps are included between step (C) and step (D):
(K) determining whether to execute an EDID review program; and
(L) if determined to execute the EDID review program, display relevant EDID.

15. The management method as claimed in claim 8, wherein step (H) further comprises:
(H1) uploading counting value data of the EDID burning device to the database of the EDID management server, and updating counter data of the EDID burning device.
